(19) United States
(12) Patent Application Publication
(10) Pub. No.: US 2009/0290949 A1
(43) Pub. Date: Nov. 26, 2009

(54) SUPPORT PLATE FOR A DUPLICATING MILLING APPARATUS

(76) Inventor: Heinrich Steger, Bruneck (IT)

Correspondence Address: LERNER GREENBERG STEMER LLP, P O BOX 2480, HOLLYWOOD, FL, 33022-2480, US

(21) Appl. No.: 12/534,260

(22) Filed: Aug. 3, 2009

Related U.S. Application Data
(63) Continuation of application No. PCT/EP2008/000697, filed on Jan. 30, 2008.

(30) Foreign Application Priority Data
Feb. 2, 2007 (AT) 180/2007

(51) Int. Cl. B23D 7/08

(52) U.S. Cl. 409/219

(57) ABSTRACT

Disclosed is a support plate for a particularly manually actuated duplicating milling apparatus. The support plate contains at least one through-hole in which a blank and a solid model are or can be disposed by one respective substantially disk-shaped retaining element. The retaining elements for the blank and the solid model are or can be arranged in the at least one through-hole so as to be pivotable about at least one substantially horizontal axis of rotation.

### CROSS-REFERENCE TO RELATED APPLICATION

This is a continuing application, under 35 U.S.C. § 120, of copending international application No. PCT/EP2008/000697, filed Jan. 30, 2008, which designated the United States; this application also claims the priority, under 35 U.S.C. § 119, of Austrian patent application No. A 180/2007, filed Feb. 2, 2007; the prior applications are herewith incorporated by reference in their entirety.

### BACKGROUND OF THE INVENTION

### Field of the Invention

The invention relates to a support plate for an, in particular manually actuatable, duplicating milling apparatus with at least one through-opening in which a shaped blank and a solid model each are or can be arranged by a substantially disk-shaped retaining element.

Duplicating milling apparatuses of this type are used above all for the manufacture of workpieces having a complex three-dimensional shape. In dentistry, duplicating milling apparatuses of this type are used, in particular, for the manufacture of inlays, onlays and crowns. In this case, a solid model is mechanically scanned by a scanning device, the deflections of the tracer pin being transmitted in synchronization to a motor-driven machining tool and the machining tool fashioning in a machining operation, for example by milling or grinding, a shaped article, which is identical to the solid model, from a shaped blank.

In Austrian utility model AT 8676 U1, the solid model and/or the shaped blank are arranged in the support plate so as to be rotatable about a vertical axis by disk-shaped retaining elements, the support plate being mounted on the duplicating milling apparatus so as to be rotatable about a substantially horizontal axis.

The fact that the retaining element has to be removed, along with the solid model, a plurality of times from the support plate during a complete milling process and be remounted in a new position, in order to allow the solid model to be machined from different sides, has been found to be a drawback of known duplicating milling apparatuses.

### SUMMARY OF THE INVENTION

It is accordingly an object of the invention to provide a support plate for a duplicating milling apparatus that overcomes the above-mentioned disadvantages of the devices of this general type, which allows a solid model to be machined from different sides without the retaining element having to be removed from the support plate and remounted again.

With the foregoing and other objects in view there is provided, in accordance with the invention, a support plate for a duplicating milling apparatus. The support plate contains substantially disk-shaped retaining elements and a support plate body having at least one through-opening in which a shaped blank and a solid model each can be disposed by the substantially disk-shaped retaining elements. The substantially disk-shaped retaining elements for retaining the shaped blank and the solid model are disposed in the at least one through-opening so as to be pivotable at least about a substantially horizontal axis of rotation.

According to the invention, the object is achieved in that the elements for retaining the shaped blank and the solid model are or can be arranged in the at least one through-opening so as to be pivotable at least about a substantially horizontal axis of rotation.

As a result of the pivotable arrangement of the retaining elements in the support plate, the invention allows the position of the retaining elements relative to the support plate to be altered without having to remove and remount the retaining elements in the support plate, such as was previously required in the prior art.

If, in this case, the two retaining elements are arranged in a through-opening so as to be pivotable about a common horizontal axis of rotation, the common pivotability of the retaining elements assumes the function of the support plate which is pivotable about a horizontal axis, i.e. the support plate itself can be arranged fixedly in terms of rotation on the duplicating milling apparatus.

In the sense of a stable solution which is simple in design, a further exemplary embodiment of the invention provides for the support plate to have at least two through-openings in each of which at least one element for retaining the shaped blank or the solid model is or can be arranged so as to be pivotable about at least one horizontal axis of rotation.

In order to be able to ensure that the shaped article milled from the shaped blank is actually identical to the solid model, it is important for the position of the solid model relative to the shaped blank to remain unaltered throughout the duplicating milling process. For this reason, a further exemplary embodiment of the invention provides for the elements for retaining the shaped blank and the solid model to be or to be able to be arranged in the at least one through-opening so as to be pivotable in synchronization, thus avoiding imprecision which can occur in the prior art as a result of the repeated removal and remounting of the retaining elements into the support plate.

According to a further exemplary embodiment, the synchronously pivoted retaining elements can be arrested by a securing apparatus for releasably positioning the retaining elements in different positions.

A preferred exemplary embodiment of a support plate according to the invention, which may be used in particular when the support plate is arranged on the duplicating milling apparatus so as to be rotatable about a substantially horizontal axis, preferably over an angle of 360°, provides for the elements for retaining the shaped blank and the solid model each to be or to be able to be arranged in the at least one through-opening so as to be pivotable about a horizontal axis of rotation, the axes of rotation of the retaining elements extending in parallel. In this case, the parallel horizontal axes of rotation of the retaining elements enclose with the horizontal axis of rotation of the support plate an angle of preferably about 90° so that, on the one hand, as a result of the pivoting of the support plate and, on the other hand, as a result of the pivoting of the retaining elements, the shaped blank can be machined in two different planes without the retaining elements thereby having to be removed from the support plate and remounted again.

According to a further exemplary embodiment of the invention, which is particularly suitable for support plates arranged fixedly in terms of rotation, the elements for retaining the shaped blank and the solid model each are or can be arranged in the at least one through-opening so as to be pivotable about two horizontal axes of rotation enclosing an angle of preferably 90°.

According to a solution which is technically simple to implement, the retaining elements are pivotably arranged in the through-opening(s) by at least one tensioning device for fixing the disk-shaped retaining elements, the tensioning device(s) being mounted on the support plate at least about a substantially horizontal axis of rotation. In other words, the tensioning device is a receptacle for the retaining element, thus allowing the retaining elements to be retained substantially uninfluenced by tension.

In order to be able to attain stable fixing of the retaining elements in the support plate, according to a further exemplary embodiment of the invention, provision is made for the tensioning device to have at least one clamping apparatus for fixing the retaining element.

It has in this case been found to be particularly advantageous if at least one tensioning device is substantially annular in its embodiment, at least partially surrounding the retaining element, and the retaining element is fixed in the tensioning device using at least one clamping apparatus, thus affording a particularly simple possibility for fixing the retaining element in the direction of support, the retaining element being in a simultaneously stable position even during the milling process.

In principle, it would also be possible to arrange the retaining element in the through-opening(s) of the support plate by merely a rotatably mounted clamping jaw. However, tests conducted by the applicant have revealed that imprecision in the milled shaped article can in this case occur as a consequence of the relatively unstable fixing and the forces acting during milling.

Imprecision can also occur when the retaining elements are fixed in the tensioning device in an insufficiently secure manner, for which reason, according to a further exemplary embodiment of the invention, provision is made for the clamping apparatus to have a clamping jaw which can be secured by a screw.

If the retaining elements are pivotably arranged in the through-opening(s) of the support plate by a tensioning device, a preferred exemplary embodiment of the invention is distinguished by at least two devices, which are mounted at least about a substantially horizontal axis of rotation, for tensioning disk-shaped retaining elements, the two tensioning devices being mechanically connected so as to be movable in synchronization. In this case, it has proven to be advantageous, for simple handling with, at the same time, stable mounting of the retaining elements, if the two tensioning devices are each mounted in the at least one through-opening so as to be rotatable about a horizontal axis of rotation, the axes of rotation of the tensioning devices extending in parallel and the two tensioning devices being coupled via a lever mechanism.

According to a particularly robust variant embodiment of the invention, provision may furthermore be made for the lever mechanism to have a first lever, which is rotatable about the axis of rotation of the first tensioning device, and a second lever, which is rotatable about the axis of rotation of the second tensioning device, and for the two, preferably one-armed, levers to be preferably rigidly connected by a coupling rod. According to a further exemplary embodiment of the invention, it has proven advantageous if the securing device is arranged and embodied for releasably positioning the coupling rod in different positions.

The manner in which the securing device is embodied is immaterial in this regard. All that is essential to the invention is the circumstance that the coupling rod and thus the retaining elements can be fixed in different positions. According to one exemplary embodiment of the invention, the securing device has for this purpose a securing screw which passes through a guideway, which is embodied or arranged on the coupling rod, and is arranged on the support plate.

The invention further relates to a duplicating milling apparatus with a support plate of the type described hereinbefore.

Other features which are considered as characteristic for the invention are set forth in the appended claims.

Although the invention is illustrated and described herein as embodied in a support plate for a duplicating milling apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE INVENTION

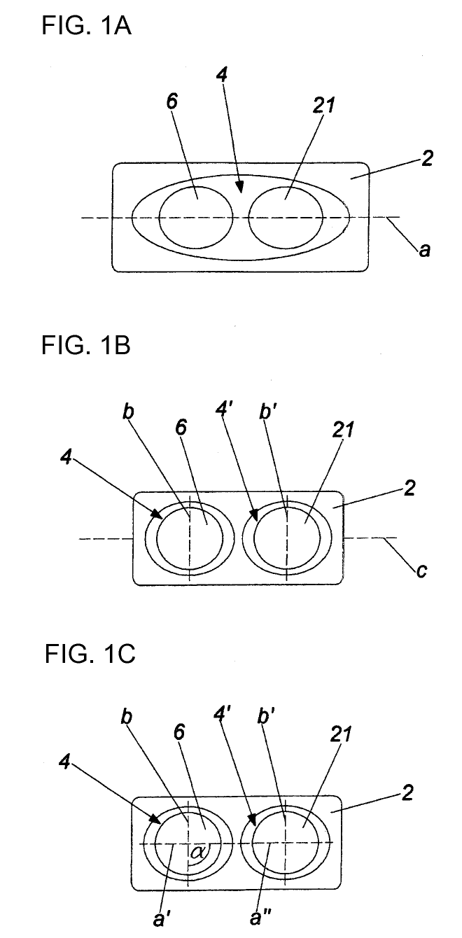

FIGS. 1A-1C diagrammatic, top plan views of a pivotable configuration of retaining elements in a support plate according to the invention;

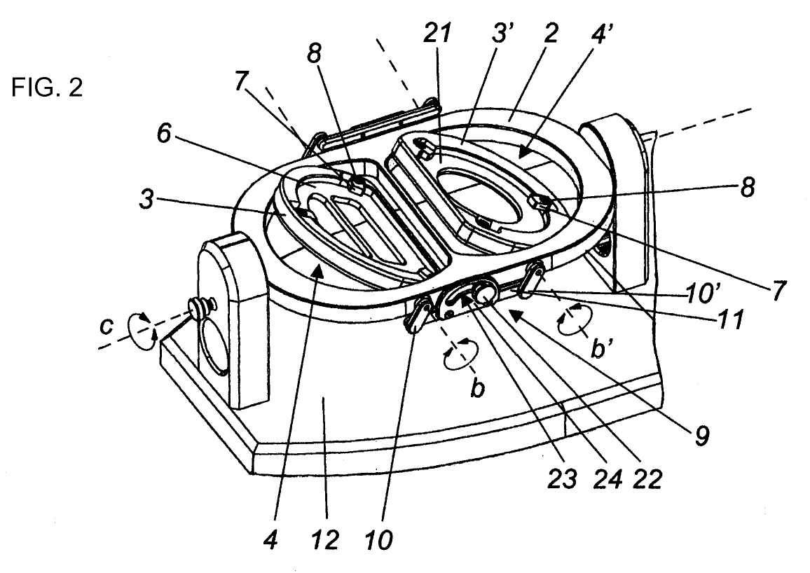

FIG. 2 is a diagrammatic, perspective view of an exemplary embodiment of the invention; and

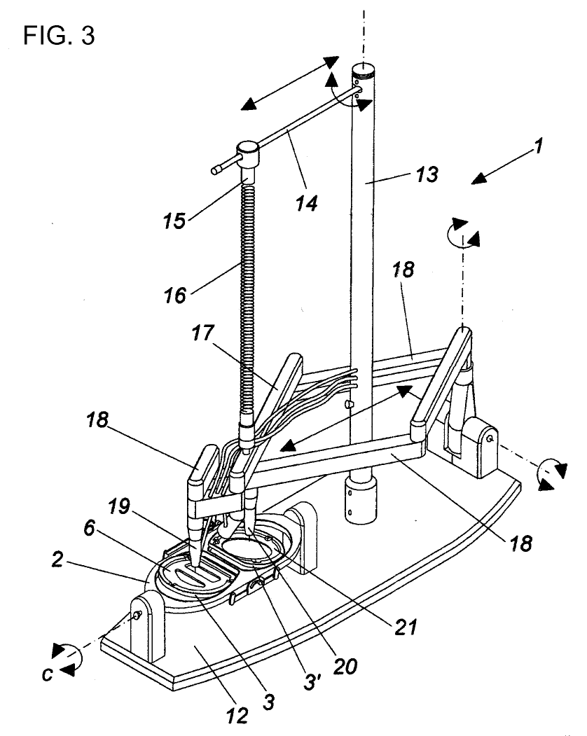

FIG. 3 is a diagrammatic, perspective view of a duplicating milling apparatus with the support plate according to the invention.

### DETAILED DESCRIPTION OF THE INVENTION

Referring now to the figures of the drawing in detail and first, particularly, to FIG. 1A thereof, there is shown, in a support plate 2, two retaining elements 6, 21 are arranged in the through-opening 4 of the support plate 2 so as to be pivotable about a common horizontal axis of rotation a. This principle will be applied above all in support plates 2 of the type arranged fixedly in terms of rotation on a duplicating milling device 1.

A further principle for mounting the retaining elements 6, 21 in the support plate 2 is illustrated in FIG. 1B. In this example, the support plate 2 is arranged on a duplicating milling apparatus so as to be rotatable about a horizontal axis c. The two retaining elements 6 and 21 are arranged in through-openings 4, 4′ of the support plate 2 so as to be pivotable about two parallel horizontal axes of rotation b, b′, the two axes of rotation b, b′ of the retaining elements 6, 21 enclosing substantially a right angle with the axis of rotation c of the support plate 2. This arrangement allows the shaped blank and a non-illustrated solid model, which are fastened in the retaining elements 6, 21, to pivot in two planes in relation to a machining tool 19 and a scanning device 20 (FIG. 3).

FIG. 1C shows a third possibility for arranging the retaining elements 6, 21 in the support plate 2 according to the invention. In this example, the two retaining elements 6, 21 are mounted in the through-openings 4, 4′ so as each to be pivotable about two horizontal axes of rotation a′, b, a″, b′ which enclose with each other an angle α of 90°. This exemplary embodiment also ensures pivotability of the shaped blank and the solid model in two planes in relation to the machining tool and the scanning device.

In the exemplary embodiment illustrated in FIG. 2, the support plate 2 is mounted on a base plate 12 of the duplicating milling apparatus 1 so as to be rotatable about a horizontal axis c. The support plate 2 has two through-openings 4, 4′ in each of which a tensioning device 3, 3′ is mounted so as to be pivotable about a horizontal axis of rotation b, b′.

The tensioning devices 3, 3′ are mechanically coupled via a lever mechanism 9 so as to be movable in synchronization. A lever mechanism 9 has for this purpose two one-armed levers 10, 10′ which are rotatable about the axes of rotation b, b′ of the tensioning devices 3, 3′ and are rigidly interconnected via a coupling rod 11. A guide element 24 is arranged on the coupling rod 11. In a guide element 24, an arcuate guideway 23 is embodied in the form of a through-opening. A securing screw 22 is arranged on the support plate 2, passing right through the guideway 23. For pivoting the tensioning devices 3, 3′, the securing screw 22 is therefore unscrewed, the coupling rod 11, guided via the guideway 23, is pivoted to the right or left and, subsequently, the tensioning devices 3, 3′ are positioned in a new position by tightening the adjustment screw 22.

In the exemplary embodiment shown, the tensioning devices 3, 3′ are annular in their embodiment and are substantially adapted in terms of shape to the retaining elements 6, 21. For fixing the retaining elements 6, 21 in the tensioning devices 3, 3′, the tensioning devices have a plurality of clamping apparatuses. In the exemplary embodiment shown, these clamping apparatuses are each formed by a clamping jaw 7 and a screw 8. For fixing the retaining elements 6, 21 in the tensioning devices 3, 3′, the retaining elements 6, 21 are therefore first inserted into the tensioning devices 3, 3′ and afterwards clamped by the clamping jaws 7 by tightening the screws 8.

Although, in the exemplary embodiment shown too, the tensioning devices 3, 3′ are annular in their embodiment, surrounding the retaining elements 6, 21, it would be quite possible for the tensioning devices 3, 3′ each to be formed by clamping apparatuses which are mounted so as to be rotatable about a horizontal axis b, b′. Irrespective of the manner in which the tensioning devices 3, 3′ are embodied, a key idea of the invention consists in arranging the retaining elements 6, 21 in the through-openings 4, 4′ of the support plate 2 so as to be rotatable, in particular movable in synchronization, about a horizontal axis a, a′, a″, b, b′.

FIG. 3 shows schematically the duplicating milling apparatus 1, wherein the support plate 2 may be discerned in particular. A vertical support 13, on which a counter bearing 15 for a spring 16 is mounted via a retaining device 14, is arranged on a base plate 12. The counter bearing 15 is mounted on the retaining device 14 so as to be displaceable in the longitudinal direction of the retaining device 14. This ensures that the counter bearing 15 of the spring 16 can follow the point of application of the spring 16 in a cantilever 17 in the event of a change of position, so that the spring 16 is oriented substantially vertically throughout the milling process. The motor-driven processing tool 19 for milling the shaped blank and also the scanning device 20 for scanning the solid model are arranged by way of a stork's bill-type arrangement of levers 18 which are connected to one another at an angle of rotation.

Obviously, the illustrated exemplary embodiments of support plates for a duplicating milling apparatus are to be understood not in the restrictive sense, but merely as individual examples of numerous possibilities for realizing the inventive idea of a support plate with retaining elements arranged in the through-openings of the support plate so as to be pivotable about a horizontal axis.

1. A support plate for a duplicating milling apparatus, the support plate comprising:
substantially disk-shaped retaining elements;
a support plate body having at least one through-opening formed therein in which a shaped blank and a solid model each can be disposed by means of said substantially disk-shaped retaining elements; and
said substantially disk-shaped retaining elements for retaining the shaped blank and the solid model being disposed in said at least one through-opening so as to be pivotable at least about a substantially horizontal axis of rotation.

2. The support plate according to claim 1, wherein said substantially disk-shaped retaining elements have axes of rotation extending in parallel.

3. The support plate according to claim 1, wherein said substantially disk-shaped retaining elements for retaining the shaped blank and the solid model each disposed in said at least one through-opening so as to be pivotable about two horizontal axes of rotation enclose an angle of preferably 90°.

4. The support plate according to claim 1, wherein said substantially disk-shaped retaining elements for retaining the shaped blank and the solid model are disposed in said at least one through-opening so as to be pivotable in synchronization.

5. The support plate according to claim 1, further comprising a securing apparatus for releasably positioning said substantially disk-shaped retaining elements in different positions.

6. The support plate according to claim 1, wherein said support plate has at least two through-openings formed therein and in each of said through-openings at least one of said substantially disk-shaped retaining elements for retaining the shaped blank or the solid model can be disposed so as to be pivotable about the horizontal axis of rotation.

7. The support plate according to claim 6, further comprising at least one tensioning device, said substantially disk-shaped retaining elements are pivotably disposed in said through-openings by means of said at least one tensioning device for fixing said substantially disk-shaped retaining elements, said tensioning device being mounted on said support plate at least about the substantially horizontal axis of rotation.

8. The support plate according to claim 7, wherein said tensioning device has at least one clamping apparatus for fixing said substantially disk-shaped retaining elements.

9. The support plate according to claim 7, further comprising at least one clamping apparatus, said at least one tensioning device being substantially annular, at least partially surrounding said substantially disk-shaped retaining elements, and said substantially disk-shaped retaining elements being fixed in said tensioning device using said at least one clamping apparatus.

10. The support plate according to claim 9, wherein said clamping apparatus has screw and a clamping jaw which can be secured by means of said screw.

11. The support plate according to claim 7, wherein said at least one tensioning device is one of at least two tensioning devices, which are mounted at least about the substantially horizontal axis of rotation, for tensioning said substantially disk-shaped retaining elements, said at least two tensioning devices being mechanically connected so as to be movable in synchronization.

12. The support plate according to claim 11, wherein said at least two tensioning devices are each mounted in said at least one through-opening so as to be rotatable about the substantially horizontal axis of rotation, said tensioning devices having axes of rotation extending in parallel.

13. The support plate according to claim 11, further comprising a lever mechanism and said two tensioning devices are coupled via said lever mechanism.

14. The support plate according to claim 13, wherein said lever mechanism has a coupling rod, a first lever, which is rotatable about the axis of rotation of a first one of said tensioning device, and a second lever, which is rotatable about the axis of rotation of a second one of said tensioning devices, and said first and second levers are rigidly connected by means of said coupling rod.

15. The support plate according to claim 14, further comprising a securing device disposed and embodied for releasably positioning said coupling rod in different positions.

16. The support plate according to claim 15, wherein said securing device has a guideway formed therein and a securing screw which passes through said guideway, said securing device one of embodied and disposed on said coupling rod, said screw being disposed on said support plate.

17. The support plate according to claim 13, wherein said first and second levers are one-armed levers.

18. The support plate according to claim 1, wherein the duplicating milling apparatus is a manually actuatable, duplicating milling apparatus.

19. A duplicating milling apparatus, comprising: a
a support plate containing:
substantially disk-shaped retaining elements;
a support plate body having at least one through-opening formed therein in which a shaped blank and a solid model each can be disposed by means of said substantially disk-shaped retaining elements; and
said substantially disk-shaped retaining elements for retaining the shaped blank and the solid model being disposed in said at least one through-opening so as to be pivotable at least about a substantially horizontal axis of rotation.

20. The duplicating milling apparatus according to claim 19, wherein said support plate is arranged on the duplicating milling apparatus so as to be rotatable about a substantially horizontal axis.

21. The duplicating milling apparatus according to claim 19, wherein said support plate is arranged on the duplicating milling apparatus so as to be rotatable about a substantially horizontal axis over an angle of 360°.
